(19) United States
(12) Patent Application Publication
(10) Pub. No.: US 2003/0214480 A1
(43) Pub. Date: Nov. 20, 2003

(54) Electronic device having an electronic display system pivotably mounted therein

(76) Inventor: Weng Wah Chng, Singapore (SG)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/151,392

(22) Filed: May 20, 2002

(51) Int. Cl. G09G 5/00

(52) U.S. Cl. 345/156

(57) ABSTRACT

An electronic device (10) having an electronic display system (12) is described. The electronic display system (12) has a support (14), a mount (16) pivotably coupled to the support (14), an electronic display (18) mounted to the mount (16), and a weight (20) mounted at a weight-mounting portion (22) of the mount (16). The weight (20) pivots the mount (16) about a pivot axis (24) such that the electronic display (18) is oriented at a desired orientation. The desired orientation corresponds to any orientation of the electronic device (10) between and including a first orientation and a second orientation.

### FIELD OF THE INVENTION

The present invention relates to electronic devices with displays. In particular, this invention relates to an electronic device having an electronic display system pivotably mounted therein.

### BACKGROUND OF THE INVENTION

Electronic devices such as, for example, portable stereos and gaming stations are known to have displays that provide information to users. Typically, a display is mounted to an electronic device such that the information is displayed for normal viewing. Such normal viewing generally requires display elements of the display to be specifically oriented. Hence, an elongated liquid crystal panel is usually mounted to display information horizontally.

However, displaying information in a specific orientation is a problem when an electronic device cannot be oriented to that specific orientation. For example, horizontal space corresponding to that specific orientation may be limited and, therefore, the electronic device has to be placed vertically or at an angle relative to that specific orientation. Consequently, it is inconvenient to read information displayed on a display for an electronic device that is placed, for example, vertically, when the specific orientation is horizontal or vice versa.

The inconvenience of reading information provided by a display that is oriented differently from a desired orientation can be resolved. A common solution is to process display data dynamically according to the desired orientation. For example, U.S. Pat. No. 5,189,408 Teicher describes an orientation-sensitive display system in which a data processor controls a visual display in accordance with the orientation of a housing for the visual display and as sensed by a gravity-sensitive device. However, re-displaying data as such requires additional elements such as the gravity-sensitive device, or a processor or controller to process the data accordingly for re-displaying. Consequently, these additional elements increase the cost of an electronic device having, for example, such an orientation-sensitive display system or the processor or controller. Furthermore, such re-displaying is typically provided when the electronic device is oriented at discrete positions that have to be detected by the gravity-sensitive device or the processor or controller. Otherwise, when a discrete position is not detected, the data cannot be processed and re-displayed for proper viewing by users.

Another method for displaying information aligned to a specific orientation is provided by PCT publication WO 08607016A1. This PCT publication describes a device that is attached to a wheel and in which an eccentric weight keeps upright a badge that is displayed on a display surface of the device. However, use of the device is limited to display surfaces that are completely rotatable. Consequently, the device cannot be used with a display surface or a display that is electrically coupled by a wire or cable to an information source that is fixed. This is because rotation of such a display surface or display for more than one revolution is likely to cause the wire or cable to twist, and this generally causes further problems. For example, a wire that is substantially twisted may break off from its mounting or undesirably engage sensitive electronic components of a display.

Therefore, a need clearly exists for an electronic device having an electronic display system for displaying information at a desired orientation without having to use processors or controllers.

### SUMMARY OF THE INVENTION

The present invention seeks to provide an electronic display system and an electronic device having the electronic display system.

Accordingly, in one aspect, the present invention provides an electronic device having:

at least one information source;

and

an electronic display system communicably coupled to the at least one information source to receive information therefrom for displaying, the electronic display system comprising:

a support;

a mount pivotably coupled to the support;

at least one electronic display mounted to the mount,

and

at least one weight mounted at a weight-mounting portion of the mount, the at least one weight being to pivot the mount about a pivot axis such that the at least one electronic display is oriented at a desired orientation.

In another aspect, the present invention provides an electronic display system, communicably coupled to at least one information source to receive information therefrom for displaying, the electronic display system having:

a support;

a mount pivotably coupled to the support;

at least one electronic display mounted to the mount;

and

at least one weight mounted at a weight-mounting portion of the mount, the at least one weight being to pivot the mount about a pivot axis such that the at least one electronic display is oriented at a desired orientation.

### BRIEF DESCRIPTION OF THE DRAWINGS

A preferred embodiment and an alternate embodiment of the present invention are more fully described, by way of example, with reference to the drawings of which:

FIG. 1 illustrates a simplified front view of an electronic device having an electronic display system pivotably mounted therein and oriented in a first orientation in accordance with the invention;

FIG. 2 illustrates a simplified front view of the electronic device of FIG. 1 oriented in a second orientation;

FIG. 3 and FIG. 4 illustrate simplified front views of the electronic device of FIG. 1 oriented in two exemplary intermediate orientations between the first orientation and the second orientation;

FIG. 5 is a cross-sectional view of the electronic device of FIG. 1 along line A-A′ showing mounting details of an electronic display of the electronic display system in accordance with the preferred embodiment;

FIG. 6 is a front view of a portion of a support of the electronic device of FIG. 1;

FIGS. 7A, 7B and 7C are simplified cut-off front views of the electronic device of FIG. 1 illustrating how pivotal movement of the electronic display system is limited by two retaining members;

FIG. 8 is a cross-sectional side view of the electronic device of FIG. 1 along line A-A′ showing mounting details of an electronic display system in accordance with an alternate embodiment; and

FIG. 9 is a front view of a section of the electronic device of FIG. 8 showing different pivot radii of a mount of the electronic display system about a pivot axis.

### DETAILED DESCRIPTION OF THE DRAWINGS

An electronic display system and an electronic device having the electronic display system pivotably mounted therein in accordance with a preferred embodiment and an alternate embodiment of the invention are described. In the following description, details are provided to describe the preferred embodiment. It shall be apparent to one skilled in the art, however, that the invention may be practiced without such details. Some of these details may not be described at length so as not to obscure the invention.

There are many advantages of the invention. One advantage of the invention is that information can be displayed when the electronic display system or the electronic device is oriented at different orientations without using electronic processors or controllers.

Another advantage of the invention is that the different orientations of the electronic display system, or the electronic device, are not restricted to discrete positions but fall within a continuous range between two end positions within the continuous range.

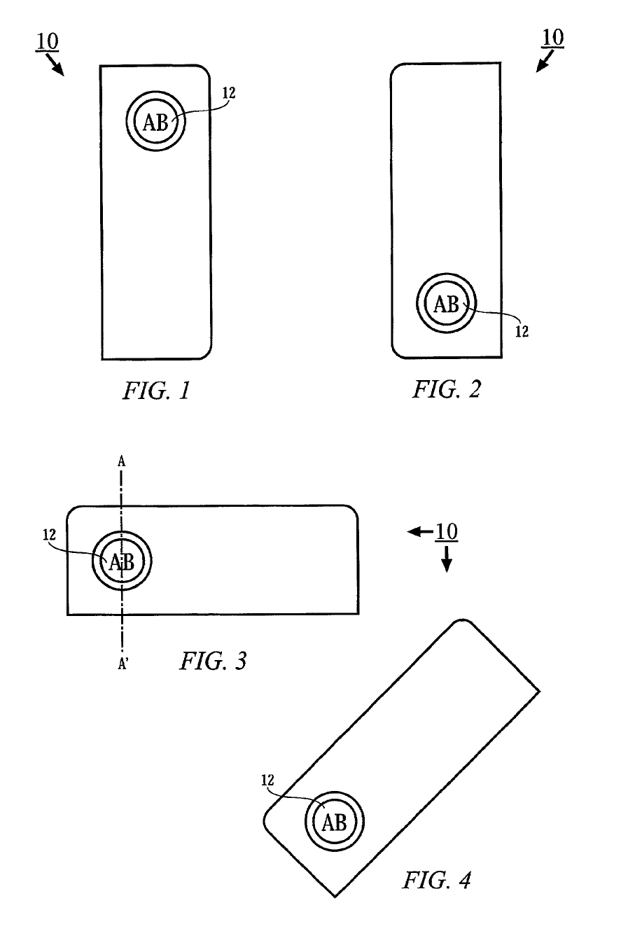

Referring now to FIG. 1, a simplified front view of an electronic device 10 having an electronic display system 12 pivotably mounted therein and oriented in a first orientation in accordance with the invention is illustrated. FIG. 2 illustrates the electronic device 10 oriented in a second orientation. Two exemplary intermediate orientations between the first orientation and the second orientation of the electronic device 10 are illustrated in FIG. 3 and FIG. 4.

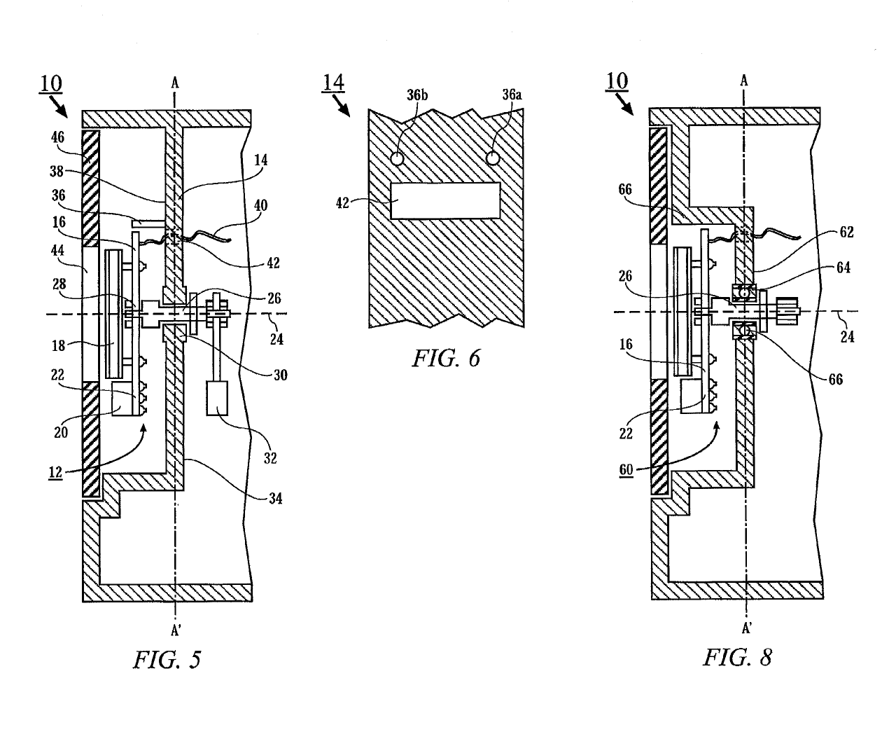

Referring now to FIG. 5, a cross-sectional view of the electronic device 10 along line A-A′ is illustrated. This cross-sectional view shows mounting details of the electronic display system 12 in accordance with the preferred embodiment.

The electronic display system 12 comprises a support 14, a mount 16 pivotably coupled to the support 14, an electronic display 18 mounted to the mount 16, and a weight 20 mounted at a weight-mounting portion 22 of the mount 16. The weight 20 pivots the mount 16 about a pivot axis 24 such that the electronic display 18 is oriented at a desired orientation.

The desired orientation corresponds to any orientation of the electronic device 10 between and including the first orientation and the second orientation as illustrated, respectively, in FIG. 1 and FIG. 2. Such a desired orientation is not restricted to discrete positions but falls anywhere within a continuous range between two end positions corresponding to first orientation and the second orientation.

The mount 16 can be, for example, a substrate for electronic circuitry of the electronic display 18. If not a circuit substrate, then the mount 16 can be made with any material such as, for example, plastics.

The support 14 comprises a pivot shaft 26 for pivotal coupling with a shaft engagement portion 28 of the mount 16 about the pivot axis 24. In the preferred embodiment, the shaft engagement portion 28 has an aperture formed by the mount 16 through which the pivot shaft 26 is fixedly mounted. The support 14 further comprises a shaft support portion 30 for supporting pivotal movement of the pivot shaft 26 about the pivot axis 24.

In the preferred embodiment, the electronic device 10 firer comprises a counter-weight 32 coupled to the pivot shaft 26. The counter-weight 32 is disposed on an opposite side 34 of the support 14 and distal from the electronic display 18 relative to the weight 20.

In the preferred embodiment, the support 14 comprises at least one retaining member for limiting pivotal movement of the mount 16 within a pivotal angle about the pivot axis 24. The pivotal angle ranges between the first orientation and the second orientation as illustrated respectively in FIG. 1 and FIG. 2. Each of the at least one retaining member comprises a protrusion 36 extending from a side 38 of the support 14.

Also shown in FIG. 5 is a communication resource 40. The electronic display system 12 is communicably coupled via the communication resource 40 to at least one information source (not shown) to receive information therefrom for displaying. Such a communication resource 40 can be a wire, a cable or a flex substrate providing that provides electrical connection to the information source.

A slot 42 is formed on the support 14 to accommodate movement of the communication resource 40 when the electronic display system 12 is pivoting. A front view of a portion of the support 14, illustrated by FIG. 6, shows disposition of the slot 42, and the protrusions 36a,36b relative to each other and to the slot 42.

FIG. 5 also shows a transparent protective cover 44 that is mounted to a front panel 46 of the electronic device 10. The transparent protective cover 44 is aligned to the electronic display 18 to enable viewing of information displayed on the electronic display 18.

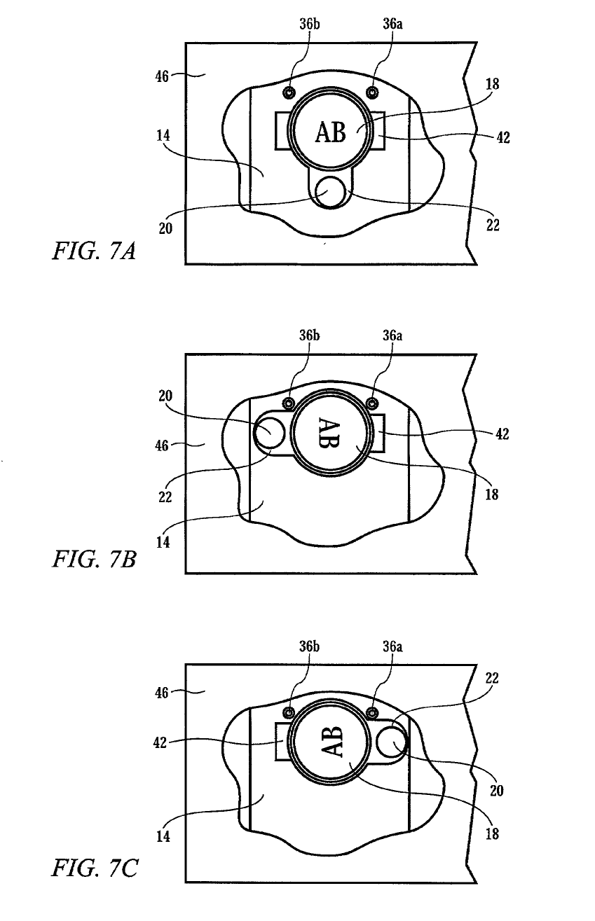

FIGS. 7A, 7B and 7C are simplified cut-off front views of the electronic device 10 illustrating how pivotal movement of the electronic display system 12 is limited by the protrusions 36a,36b. FIG. 7A shows the electronic display system 12 orientated corresponding to the intermediate orientation shown in FIG. 3. FIG. 7B shows pivotal movement of the electronic display system 12 being limited by the protrusion 36b if the electronic device 10 should pivot towards the first orientation shown in FIG. 1. FIG. 7C shows pivotal movement of the electronic display system 12 being limited by the protrusion 36a if the electronic device 10 should pivot towards the second orientation shown in FIG. 2.

As illustrated in FIGS. 7B and 7C, the pivotal angle about the pivot axis 24 ranges between the first orientation and the second orientation. Therefore, the pivotal angle has an angular range of about 180 degrees in this preferred embodiment. However, this angular range depends on positioning of the protrusions 36a,36b and also to what extend the electronic display system 12 is able to pivot without having problems of displaying information due to twisting of the communication resource 40.

FIG. 8 is a cross-sectional side view of the electronic device 10 along line A-A′ showing mounting details of an electronic display system 60 in accordance with an alternate embodiment. In this alternate embodiment, the electronic display system 60 comprises a support 62 and a shaft support portion 64. The support 62 has a retaining portion 66 that engages the weight-mounting portion 22 of the mount 16.

The shaft support portion 64 comprises a plurality of ball bearings 66 mounted thereat to support pivoting of the mount 16 about the pivot axis 24. use of the plurality of ball bearings 66 enables rotation of the pivot shaft 26 about the pivot axis 24.

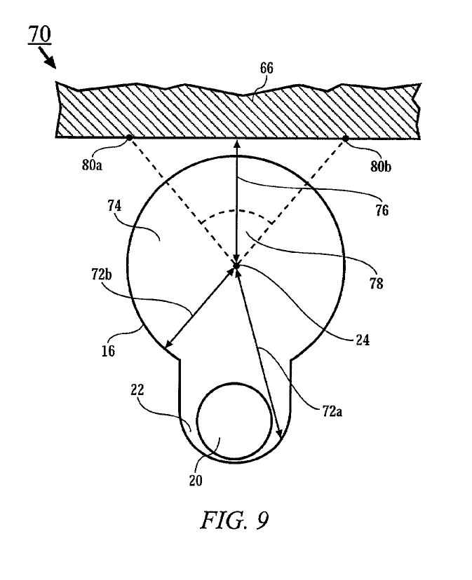

Referring now to FIG. 9, a front view of a section 70 of the electronic device 10 showing different pivot radii 72 of the electronic display system 60 about the pivot axis 24. The pivot radius 72a at the weight-mounting portion 22 is larger than the pivot radius 72b of remaining portion 74 the mount 16.

The retaining portion 66 has a range of distances from the pivot axis 24. The shortest distance between the pivot axis 24 and the retaining portion 66 is indicated as a distance 76. The range of distances from the pivot axis 24 to the retaining portion 66 has lengths that are between the pivot radius 72a at the weight-mounting portion 22 and the pivot radius 72b at the remaining portion 74. Consequently, pivotal movement of the mount 16 about the pivot axis 24 is limited when the weight-mounting portion 22 reaches the retaining portion 66. The retaining portion 66 therefore prevents filter pivotal movement beyond a pivotal angle 78 between two positions 80a,80b of the retaining portion 66.

The present invention thus provides the electronic device 10 and the electronic display system 12 to overcome, or at least alleviate, the problems of displaying information at a desired orientation without having to use processors or controllers.

It will be appreciated that although only one preferred embodiment has been described in detail, various modifications and improvements can be made by persons skilled in the art without departing from the scope of the present invention.

1. An electronic device having:
at least one information source;
and
an electronic display system communicably coupled to said at least one information source to receive information therefrom for displaying, said electronic display system comprising:
a support;
a mount pivotably coupled to said support;
at least one electronic display mounted to said mount;
and
at least one weight mounted at a weight-mounting portion of said mount, said at least one weight being to pivot said mount about a pivot axis such that said at least one electronic display is oriented at a desired orientation.

2. The electronic device of claim 1, wherein said support comprises a pivot shaft for pivotal coupling with a shaft engagement portion of said mount.

3. The electronic device of claim 2, wherein said support further comprises a shaft support portion for supporting pivotal movement of said pivot shaft about said pivot axis.

4. The electronic device of claim 3, wherein said shaft support portion comprises a plurality of ball bearings mounted thereat.

5. The electronic device of claim 2, and further comprising at least one counter-weight coupled to said pivot shaft.

6. The electronic device of claim 5, wherein said at least one counter-weight is disposed on an opposite side of said support and distal from said at least one electronic display relative to said at least one weight.

7. The electronic device of claim 1, wherein said support comprises at least one retaining member for limiting pivotal movement of said mount within a pivotal angle about said pivot axis.

8. The electronic device of claim 7, wherein each of said least one retaining member comprises a protrusion extending from a side of said support.

9. The electronic device of claim 1, wherein said mount has a pivot radius about said pivot axis, said pivot radius of said mount at said weight-mounting portion being larger than said pivot radius of remaining portion of said mount.

10. The electronic device of claim 9, wherein said support comprises a retaining portion, said retaining portion having a range of distances from said pivot axis, said range being between said pivot radius of said weight-mounting portion and said pivot radius of said remaining portion.

11. The electronic device of claim 1, wherein said mount is a substrate.

12. An electronic display system, communicably coupled to at least one information source to receive information therefrom for displaying, said electronic display system having:
a support;
a mount pivotably coupled to said support;
at least one electronic display mounted to said mount;
and
at least one weight mounted at a weight-mounting portion of said mount, said at least one weight being to pivot said mount about a pivot axis such that said at least one electronic display is oriented at a desired orientation.

13. The electronic display system of claim 12, wherein said support comprises a pivot shaft for pivotal coupling with a shaft engagement portion of said mount.

14. The electronic display system of claim 13, wherein said support further comprises a shaft support portion for supporting pivotal movement of said pivot shaft about said pivot axis.

15. The electronic display system of claim 14, wherein said shaft support portion comprises a plurality of ball bearings mounted thereat.

16. The electronic display system of claim 13, and further comprising at least one counter-weight coupled to said pivot shaft.

17. The electronic display system of claim 16, wherein said at least one counter-weight is disposed on an opposite side of said support and distal from said at least one electronic display relative to said at least one weight.

18. The electronic display system of claim 12, wherein said support comprises at least one retaining member for limiting pivotal movement of said mount within a pivotal angle about said pivot axis.

19. The electronic display system of claim 18, wherein each of said least one retaining member comprises a protrusion extending from a side of said support.

20. The electronic display system of claim 12, wherein said mount has a pivot radius about said pivot axis, said pivot radius of said mount at said weight-mounting portion being larger than said pivot radius of remaining portion of said mount.

21. The electronic display system of claim 20, wherein said support comprises a retaining portion, said retaining portion having a range of distances from said pivot axis, said range being between said pivot radius of said weight-mounting portion and said remaining portion.

22. The electronic display system of claim 12, wherein said mount is a substrate.
